(19) United States
(12) Patent Application Publication
(10) Pub. No.: US 2004/0064398 A1
(43) Pub. Date: Apr. 1, 2004

(54) Method and system for financing publicly traded companies

(76) Inventors: Spencer I. Browne, Denver, CO (US); Gary J. Graham, Aurora, CO (US); Michael Van Norstrand, Littleton, CO (US)

Correspondence Address: Steven B. Pokotilow, Esq., Stroock & Stroock & Lavan LLP, 180 Maiden Lane, New York, NY, 10038, US

(21) Appl. No.: 10/407,104

(22) Filed: Apr. 4, 2003

Related U.S. Application Data
(60) Provisional application No. 60/414,086, filed on Sep. 26, 2002.

(51) Int. Cl. G06F 17/60

(52) U.S. Cl. 705/37

(57) ABSTRACT

A method and system for financing publicly traded companies. According to one embodiment, a client provides collateral for receiving financing. Such collateral includes, on one hand, pledged assets, for example, accounts receivable, equipment, inventory real estate and the like, and on the other hand, stock. The stock is transferred to an entity, such as a limited liability company (LLC). The stock may be liquidated throughout the term of the financing or upon default by the client. If the client defaults, the cash and stock are provided to the lending party; where the LLC is majority owned by the client and the client does not default, at the end of the term, the client has a funded financing company in the form of the LLC.

### CROSS-REFERENCE TO RELATED APPLICATIONS

The present application claims the benefit under 35 USC Section 119(e) of U.S. Provisional Patent Application Serial No. 60/414,086, filed Sept. 26, 2002, entitled “Method and System for Financing Publicly-Traded Companies”, which application is hereby incorporated herein by reference.

### BACKGROUND OF THE INVENTION

1. Field of the Invention

This invention relates to a method and a system for providing financing and, more particularly, for providing secured working capital and fixed-asset-based financing suitable for middle-market, publicly traded companies that typically have credit needs outside of traditional commercial bank underwriting guidelines.

2. Description of Related Art

The first widespread, documented use of asset-based financing occurred in the American colonies before the revolution when companies began financing accounts receivable. During this time, cotton, furs and timber were shipped from the colonies to various parts of Europe. Merchant bankers throughout Europe advanced funds to the colonists for these raw materials, before they reached the continent. This enabled the colonists to continue to harvest their new land and continue business operations, free from the burden of waiting to be paid by their European customers.

Asset-based financing has proven to possess many advantages. An asset-based credit line enables a business to operate with financial flexibility with the following benefits: (a) protects and improves the company's credit rating by securing an ongoing means of meeting maturing financial obligations; (b) provides additional flexibility in managing cash flow; and (c) assures access to a continuous source of working capital to: (1) take advantage of cash discounts for raw materials; (2) increase the company's purchasing power; (3) fulfill large purchase orders; (4) rapidly expand and accelerate production without adding new debt; (5) provide cash for rapidly expanding and growing revenues; (6) grant better credit terms to customers; (7) reduce the cost of managing accounts receivable; (8) retire more expensive debt; and (9) provide greater financial liquidity.

Consequently, asset-based financing has become a traditional financing option for U.S. businesses. In fact, a vast majority of middle-market companies and many Fortune 500 companies use asset-based financing for cash flow management. This is particularly true during periods of a softening economy when traditional capital sources and conventional lending institutions throughout the U. S. react to a tight credit market by limiting their investing and lending activities to only the largest, investment-grade public companies.

According to the 2001 Commercial Finance Association (CFA) marketing research report, asset-based lending in the United States is a $342 billion-plus market. By revenues, most of these borrowers (71%) are middle market companies, under $100 million in size. Since 1976, the compound growth rate in asset-based lending has averaged 15 percent. Industry growth has continued to rise every year for the 10-year period beginning in the early 1990's, with double-digit growth occurring continuously over the last 8 years of that period. The CFA reports that this segment of the marketplace provides one of the largest sources of commercial credit in the U.S. This is consistent with Federal Reserve figures, which indicate that asset-based lenders accounted for 21 percent of all new short-term lending in the United States in 2001. Although in 1976, the industry grew by only $856 million, or 7.2 percent, in the single year of 2001, the growth rate was 2.3 times higher and the dollar volume was 29 times greater than in 1976, which indicates a strong and long-term upward trend.

These growth trends are expected to continue, if not accelerate, throughout the 2004-2006 period, primarily as a result of the economy and tight capital markets. It is evident that asset-based lending is a necessary industry, especially for middle-market companies.

Though a demonstrated necessity, the asset-based lending industry, as it has matured, has become more commodity-like and much more competitive. These two factors have conspired to compress margins. As a result, specialty finance companies, e.g., those offering commercial or consumer non-bank financing products or services that result in higher profit margins than banks, have found it more difficult to be profitable. Indeed, the global financial slowdown in the 2000-2001 period has exposed many operating model deficiencies in this sector and has precipitated the systematic elimination of less equipped competitors. With lending capacity still exiting the marketplace, coupled with the continual elimination of numerous marginal competitors, the industry is increasingly in need of participants with more secure, innovative approaches to asset-based lending.

Accordingly, it is manifest that there is a need for specialty finance companies to have available to them a method for financing middle-market, publicly traded companies that is not presently being met.

### SUMMARY OF THE INVENTION

The present invention satisfies this and other needs. A method according to one embodiment of the present invention uses a combination of traditional asset-based financing and listed (free trading) stock to significantly increase the borrowing capacity of publicly traded companies. By using this combination of commercial and investment banking practices, the present invention provides a variety of growth and working capital loans to middle-market public companies.

In certain embodiments the method provides for a mechanism whereby a company can increase its borrowing potential up to about 30% or more than the current market advance rate of 60% to 80% being offered by traditional bank lenders. This is accomplished by taking affiliate or non-affiliate (greater than one-year hold), shelf-registered (Form S-3 or Form SB-2) and free trading, registered shares as collateral in addition to traditionally pledged fixed assets . Depending on the structure of a particular lending relationship, the pledged shares may be held as collateral, to be liquidated upon default, or may otherwise be liquidated in accordance with a financing plan, the proceeds thereof held in a surplus collateral account. In other embodiments, assets other than accounts receivable, either alone or in combination with accounts receivable, arc used as the base collateral.

One embodiment of the method utilizes a computerized communications network connecting a plurality of publicly traded companies seeking to secure financing and comprises the following steps:

(a) receiving at least one application for a loan from one of the plurality of companies including information identifying at least (i) the name of the company, (ii) the assets having a value, V, to be pledged as collateral to secure funding, and (iii) the number, N, of shares of a listed stock having a price per share, P, to be pledged as additional collateral to secure the funding;

(b) determining the advance rate percentage, R, of the pledged assets;

(c) determining the total stock collateral value (N×P) to excess loan amount (A−(R×V)) ratio, M, after a risk analysis based in part upon the company, the pledged accounts receivable, and stock (where M can not equal less than 2); and,

$$M = \frac{( N \times P )}{( A - ( R \times V ) )}$$

(d) approving the loan in the amount, A, where:

$$A = ( R \times V ) + \frac{( N \times P )}{M}$$

In such embodiment, during the term of the loan, the value of stock and cash in the surplus collateral account must remain at least at the fixed multiple (M) times the amount of the excess loan amount (A−(N×P)). In the event of a stock price decline, a pledge of additional shares must be made to replenish the stock collateral. At the end of the term of the financing, the balance of cash, less offsets and fees, will be returned to the client or customer of the method of the present invention.

Because of the unique combination of fixed asset and stock collateral, the present method can reduce the loan-to-collateral ratio by about 10% or more from a traditional receivable ratio of about 80%, resulting in less lending risk than traditional loans. Moreover, financing under the present invention generates significantly more revenue than traditional accounts receivable loans as result of collateral management fees, monthly stock liquidations, cash deposits and residual fees.

Furthermore, certain embodiments also enhance factoring and lease financing transactions. For example, public companies can now achieve a 20% to 25% increase in cash flow by using the present invention in factoring their receivables. The diversity of the present method is greatly increased by including these other financing opportunities.

### BRIEF DESCRIPTION OF THE DRAWINGS

Further features, advantages and a more particular description of the preferred embodiments of the invention follow, with reference to the accompanying drawings:

FIG. 1A is a block diagram of an overview of the “initial” legal/business structure of one embodiment of the present invention.

FIG. 1B is a block diagram of an overview of the “final” legal structure of one embodiment of the present invention.

FIG. 2 is a block diagram of the system architecture of one embodiment of the present invention.

FIG. 3 is a block diagram of the operational flow of one embodiment of the present invention.

FIG. 4 is a block diagram of the loan processing flow of one embodiment of the present invention.

FIG. 5 is a block diagram of the accounts receivable processing flow of one embodiment of the present invention.

FIG. 6 is a block diagram of a stock portfolio management flow of one embodiment of the present invention.

FIG. 7A is a block diagram of an overview of the legal structure of an alternate embodiment of the present invention.

FIG. 7B is a block diagram of a factoring flow of one embodiment of the present invention.

### DETAILED DESCRIPTION OF PREFERRED EMBODIMENTS

Certain embodiments of the present invention will now be described with reference to the aforementioned figures.

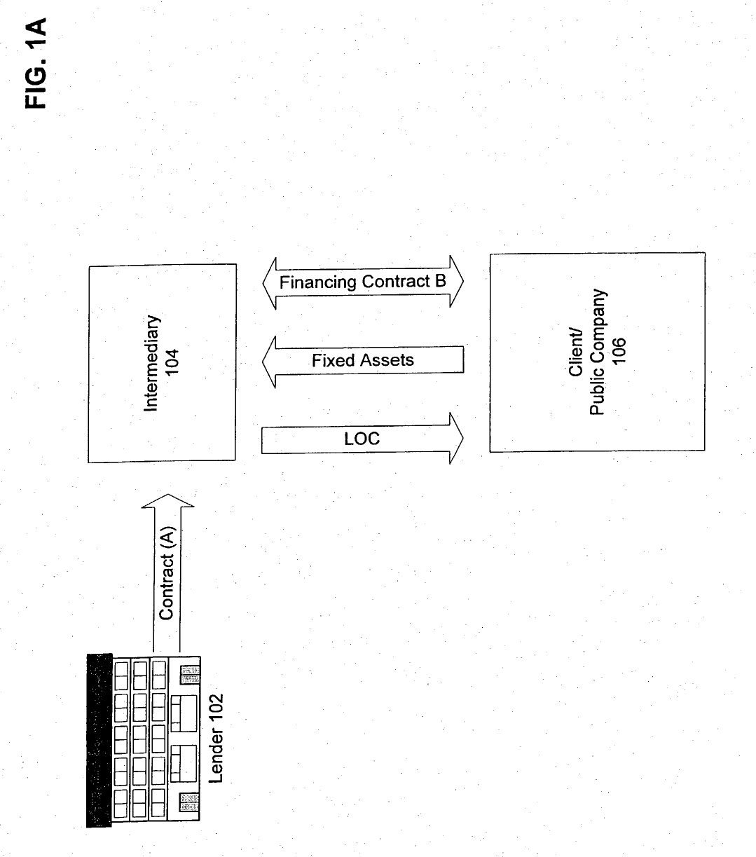

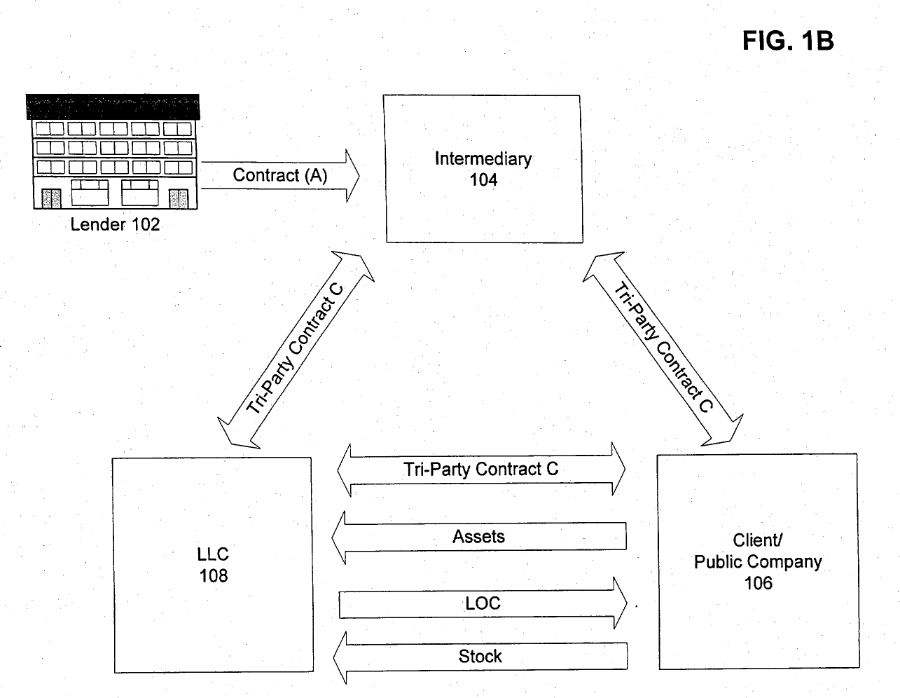

In general, the present embodiment involves a financing Program whereby a public company's accounts receivable, inventory, real estate, equipment and/or other assets are pledged in conjunction with stock as collateral to provide loans to increase borrowing potential and to decrease collateral-to-loan ratios. The stock provides the extra security allowing these results. The present exemplary Program includes three structures: the Premium, Basic and Third Party Pledge Structures. A particular client could enter into any one or more of these structures concurrently or at different times. The Basic and Third Party Pledge Structures of the present embodiment involve three entities: the lender, which provides the loan or line of credit, an intermediary or service bureau, which receives the line of credit, provides asset servicing and collection services, and the client company, which receives the line of credit. The relationships among these entities will be discussed in greater detail below with reference to FIG. 1A.

The Basic and Third Party Pledge Structures may lead to implementation of the Premium Structure, or the client may initially engage the intermediary to provide the Premium Structure. The Premium Structure of the present embodiment involves four entities: the lender, the intermediary, the client company and a forth legal entity, such as a limited liability company, which is formed to receive client stock which serves as collateral for the line of credit. The relationships among these entities is described in greater detail below with reference to FIG. 1B.

As noted above, the structures of the present financing Program provide clients with the ability to achieve a relatively high advance rate and provide intermediaries and lenders with relatively low loan to collateral ratios. For example, in the current lending environment, with some exceptions, a public company pledging $10,000,000 in accounts receivable typically can borrow $6,000,000 to $8,000,000 (or 60% to 80% of its receivables). However, with the method of the present embodiment employing either the Basic, Third Party Pledge or Premium Structure, that company may qualify to borrow about 30% or more, creating a significant cash flow advantage. For example, if the above company desires to borrow $10 million, in addition to pledging $10 million in receivables, it will pledge some amount of its company stock as collateral, in certain embodiments, equal to between two and five times the over-advance amount. Assuming, for illustrative purposes, the value of the pledged stock is three times the over-advance rate ($6 million in stock vs. $2 million over-advance) in stock collateral, the loan-to-collateral ratio is approximately 62% ($10 million/$16 million), representing a decrease of 22% from the traditional 80% ratio.

To determine the requisite number of shares to be pledged, a detailed analysis of the borrower, its pledged fixed assets and its stock type and performance is conducted to determine the M, R and P components of the following formulae:

$$M = \frac{( N \times P )}{( A - ( R \times V ) )} and A = ( R \times V ) + \frac{( N \times P )}{M}$$

Where:

A=loan amount;

V=the value of the assets to be pledged as collateral to secure funding;

N=the number of shares of a listed stock having a price per share, P, to be pledged as additional collateral to secure the funding;

R=the advance rate percentage of the pledged assets ; and

M=the ratio of the total stock collateral value (N×P) to excess loan amount (A−(R×V)) after a risk analysis based in part upon the company, the pledged accounts receivable, and stock.

R is typically between 50% and 80%, depending upon the nature of the asset, and is generally determined in accordance with standard asset-based lending credit criteria, for instance, the make-up, aging, and turnover of receivables, and the make-up and liquidation value of inventory, equipment and real estate. M is typically between two and five, but in some circumstances may be as low as one, and is determined in accordance with standard investment analyst criteria such as liquidity, number of shares pledged as collateral, capitalization, the value of the stock, prior trading activity, the credit risk associated with the non-stock collateral and other business factors.

Thus, in the present example, when M=3, and R=80% (the receivable advance rate) and P=$1.00 (stock trading price), as applied to the formulae (reformatted to solve for N) as follows:

$$N = \frac{M \times ( A - R \times V )}{P}$$

$$N = \frac{3 \times ( 10 , 000 , 000 - 8 , 000 , 000 )}{\$1 .00}$$

N=6,000,000, shares

In this example, a total loan of $10,000,000 would be collateralized by $16,000,000, (i.e., $10 million in receivables and $6 million in stock). It should be understood that the scope of the present invention may include the use of assets other than accounts receivable as collateral (alone or in combination) in conjunction with stock. In such embodiments, the typical advance rates differ based on the asset and, thus, the relative benefit of the present invention differs accordingly.

The Program of the present embodiment has three different structures to accommodate the needs of typical clients that have contracted to become financed in accordance with the present method. It is to be understood that the flexibility of the Program enables, but does not require, a client to start with a Basic structure and then move up to the Premium structure. Each of the structures will now be discussed in greater detail.

Premium Structure:

The Premium Structure of the present embodiment involves the public company using its free-trading stock to collateralize the over-advance amount (i.e., the amount of the loan that exceeds the traditional credit limit of pledged base assets). Generally, this additional collateral will be valued at between two and five times the amount of the over-advance, with the number of shares pledged equal to two percent or less of the outstanding shares of the client to ensure sufficient liquidity, although other ranges are possible. Once the stock registration is effective, the stock will be liquidated, for example, on a pro-rata basis, over the term of the loan (approximately 1.67% per month over a 60 month term), resulting in a substantial cash reserve available to the company at the end of the loan term. The client's average trading volume preferably is sufficient to minimize the market and valuation effects of the monthly liquidations required by the Program.

A separate corporate entity, such as a limited liability company (“LLC”) or other type of entity, is formed to serve as a finance company and for the purpose of taking title to the shares to be registered. Client remains responsible for complying with applicable federal and state corporate and tax laws (e.g., Client consolidates balance sheets).

Once issued, the Client contributes the determined requisite number of shares of its stock (N) to the LLC in exchange for a majority (e.g., 51%) membership interest. The intermediary retains a minority interest in the LLC.

The LLC takes title to the contributed shares. Client, as majority member of the LLC, votes such shares. In alternate embodiments, the client need not have a majority interest in the LLC. In certain of such embodiments, the entity owning the majority interest agrees to vote the share in accordance with the client's instructions. LLC members (Client and the intermediary) agree to a liquidation plan involving the contributed shares.

Preferably, at the end of the first year, the cash proceeds of liquidations should cover the asset borrowing base amount. The stock and cash is held in a Surplus Collateral Account. Preferably, the value of the Surplus Collateral Account is subject to a margin requirement, whereby the client company must add additional shares to the LLC to maintain the value of the account over a set value, for example twice the amount of the over advance of the loan. At the end of the term of the loan, the balance of the cash and stock (less any fees) is returned to the client or remains in the finance company which is owned by the client, provide there is no default.

The LLC provides Client with a loan or revolving line of credit (“LOC”) up to, or in some cases, in excess of 100% of Client's pledged non-stock assets. Client pledges its assets, as well as its LLC membership interest, as collateral for the LOC. Thus in the event of default, intermediary takes title to the assts and, by virtue of ownership of the LLC, title to the Surplus Collateral Fund and non-liquidated stock.

The LLC out-sources Client's accounts receivable (if used as the pledged base asset), management and stock liquidation processing to the intermediary. Although various structures are possible, in the present embodiment, management/loan contract with the intermediary (“Contract”) includes the following provisions:

a. Provision to LLC of a revolving LOC equal to the amount that LLC provides to Client. To secure this LOC, LLC assigns to the intermediary all collateral taken from Client. LLC pays loan fees (in the present embodiment, actually passed through from Client to LLC to the intermediary). For example, these include origination fees and interest.

b. As additional consideration for the LOC, the intermediary receives the remainder (e.g., 49%) membership interest in LLC. There are no distributions to members of the LLC while the Contract is in effect, and losses are shared, for example, 99% Client/1% intermediary.

c. The intermediary is elected Manager of the LLC for the period of time the LOC is outstanding. Contract may be terminated at any time upon payment in full of the LOC; however, Contract preferably contains early termination penalties and/or buyout provisions.

d. The intermediary manages the pledged assets and LLC stock portfolio. The stock is liquidated at the end of the loan term or over the term of the loan, for example, monthly, on a pro-rata basis, and held in a surplus collateral Cash Account. Preferably, the average trading volume is sufficient to minimize the market and valuation effects of these liquidations. As the surplus collateral account grows, the client may increase its credit line accordingly, e.g., on a one-to-one basis, using the cash as collateral. At the end of the loan term, this results in a substantial cash reserve, less the principle balance of the excess loan amount and any fees, available to the client company.

e. The intermediary receives collateral management and other fees, which together with any defaults and other set offs, are deducted directly from the surplus collateral account.

f. At the end of the Contract, the LLC membership interest of the intermediary is transferred to Client, thereby securing 100% ownership of the LLC, which, in essence, the client's own, fully funded financing company. At that time, the LLC can license the present method and any associated implementation, including computer and software platform, in order for the Client to operate the LLC itself, the LLC can continue to contract with the intermediary for such operation, or the LLC may be dissolved.

Thus, the Premium Structure of the present embodiment is summarized as follows:

1. Uses Free-Trading Stock as Collateral.

2. S-3 or SB-2 Filings Required/SEC Approval Process.

3. Monthly Stock Liquidations/Collateral Surplus Account.

4. Monthly Collateral Management Fee (e.g., 0.25%).

5. A limited liability company is formed as the Client's finance company. At the end of the loan term, the LLC becomes the fully-funded, wholly-owned finance company of the Client.

Basic Structure:

Because the value of the M in the aforementioned equation will often be fixed at between two and five, creating a 2:1 to 5:1 ratio of stock value to excess loan, some publicly traded client companies, especially those that are thinly traded, may not want to use free-trading stock as the entire collateral. In some cases, company affiliates (as that term is used in Section 144 of the Securities Act of 1933) such as management or board members or non-affiliates owning restricted stock, may be willing to put up their stock, as collateral and, in certain embodiments, possibly in conjunction with the company's free trading stock. Also, restricted stock used as collateral does not require SEC approval, eliminating the time concerns associated with the SEC process. As such, restricted stock may be used at the beginning of the financing relationship to secure increased borrowing potential while the client waits for SEC approval. Thereafter, the client may use its free-trading stock as collateral—or a combination of both free-trading and affiliate stock. The Basic Structure offers the same increased borrowing potential, but without the added benefit to the client of owning its own financing company at the end of the loan term. Also, because the restricted stock is owned by third party affiliates and non-affiliates, such parties will generally not authorize stock liquidations except in the event of a loan default; therefore, there are no (monthly) stock liquidations and, consequently, no cash available to the client in a Surplus Collateral Account.

Thus, the Basic Structure of the present embodiment can be summarized as follows:

1. Uses Affiliate Stock as Collateral. This stock must have been held at least one year because pursuant to Section 144, once past the one year holding period, restricted stock may be sold publicly within prescribed volume limits. This is important because the stock will need to be liquidated in the event of a loan default. No SEC Approval Required.

2. No Monthly Stock Liquidations/Collateral Surplus Account.

3. Higher Monthly Collateral Management Fee (relative to Premium Structure, e.g., 0.50%)

4. Can be used in conjunction with the Premium or Third Party Pledge structure.

Third-Party Pledge Structure:

In some embodiments, one or more third parties (e.g., individual or legal entity) put up their free-trading stock as collateral for the loan. Generally, this is regarded as non-affiliate stock and does not require SEC approval. Typically, the client company will provide additional incentives to the third party for using its stock as collateral. This Program structure has the same features, benefits and costs as the Basic Structure. These Programs/structures can be used as stand-alone structures or in conjunction with each other to achieve the financing needs of the client.

Thus, the Third Party Pledge Structure of the present embodiment can be summarized as follows:

1. Uses Non-Affiliate (Free Trading) Stock as Collateral.

2. No SEC Approval Required.

3. No Monthly Stock Liquidations/Collateral Surplus Account.

4. Higher Monthly Collateral Management Fee (relative to the Premium Structure, e.g., 0.50%).

5. Can be used in conjunction with Basic or Premium Structures.

Receivables-based/Factoring Financing:

In addition to the three Program structures, the intermediary has the ability to provide to the client traditional asset-based financing and factoring, with or without recourse, without the use of stock as collateral. In some cases, the user may engage in this basic-type of financing when it sees the potential of moving the client into the other Program structures.

The Program, through the various structures, has the effect of providing mezzanine financing, which is essential, but increasingly unavailable to middle-market, public companies, at costs comparable with traditional mezzanine financing. These costs include fees collected by the intermediary, which, by way of example, include:

1. Loan Origination Fee: One to two percent of the value of the loan commitment, plus filing fees;

2. Interest Rate Spread: A variable interest rate based on the U.S. Prime Rate—plus 1% to 2%;

3. Residual Fees: At the end of the loan term or as the initial credit line is increased (whichever comes first), a charge of a 5% fee on the residual cash in the Surplus Collateral Account.

4. Collateral Management Fees: Depending upon the structure of each transaction, a monthly management fee charge between 0.25% and 0.50% of the value of the stock collateral.

5. Interest on Surplus Collateral Account. Interest will be earned at market rates on the cash (resulting from monthly stock liquidations) that is deposited into the Surplus Collateral Account.

6. Additional Incentives: In some circumstances, stock options and other incentives may be required as part of the loan agreement.

Clients are preferably required to make a borrowing commitment from $500,000 to $10 million for a term of three to five years in the Program. There may be exceptions to this rule, but generally the intermediary will seek to establish a long-term contract in order to leverage its financing relationship with the client to obtain other financing opportunities, e.g., leasing and factoring, over the life of the loan.

To summarize, the Program represents a significant opportunity to attract well-managed growth companies, particularly in an environment having any one or more of the following key factors: 1. U.S. banks and other financial institutions having substantially tightened credit; 2. Assess to U.S. capital markets being virtually non-existent; and 3. Vendor financing being reduced or eliminated. Furthermore, such companies will be attracted by: 4. Intermediary providing up to 30% or more in increased in working capital; 5. Upon the successful completion of the Program, the cash in the reserve account belongs to the client; and 6. Intermediary providing a way for the client to have its own finance company—paid for by stock rather than investment capital.

Although suitable for use with a variety of companies, the present financing is particularly suited for (a) high-growth companies, (b) with a constant need for working capital, and that (c) generally do not have access to more mature lending sources. By offering the specialty financing Program to this highly targeted market, the working capital needs of the clients can be met.

Legal/Business Structure of the Present Embodiment:

Having described the Program and the entities involved in providing the Program, the legal/business relationships among the entities of one embodiment of the method of the present invention will now be discussed in greater detail. Turning to FIG. 1A, the relationships most typically for use at the beginning of a financing relationship, i.e., with the Basic and Third Party Pledge structures, as well as with traditional asset-based financing, will now be described. Three key entities are represented: source of funds or Lender 102; the Intermediary lender and operations service bureau 104; and the Client company/borrower 106. This legal structure allows companies to borrow in accordance with standard asset-based advance rates while the stock registration process is completed.

Lender/Intermediary Contract (A), identifies the terms and conditions of the primary LOC provided by Lender 102 to Intermediary 104. This LOC may be secured either by the Contract (B) between Intermediary 104 and the Client 106, by assignment of the client's pledged assets and/or Rule 144 restricted or non-affiliate, free trading stock, if applicable, or by other means required by the Lender 102. As also described above, Intermediary 104 contracts with Client 106. Contract (B) identifies the terms and conditions of the LOC provided by Intermediary 104 to the Client 106, including the terms by which the LOC is secured by the client's/public company's fixed assets and/or Rule 144 restricted or non-affiliate, free-trading stock, if applicable, as collateral.

Having generally described the Premium Program Structure and the entities involved therein, the key contracts and their provisions employed in this Structure of the Program will now be described with reference to FIG. 1B. In the event Client desires to issue its own stock to secure financing under the Premium Structure, a different type of structure is required. This structure is demonstrated in FIG. 1B and includes four key entities: the Lender 102; Intermediary 104; and the Client 106 discussed in connection with FIG. 1A, and a separate financing company, such as LLC 108 as the operating entity organized for each Client (106).

As with the Basic and Third Party Pledge Structures, the Premium Structure includes a Lender/Intermediary Contract (A) that sets forth the terms and conditions of the primary LOC provided by Lender 102 to Intermediary 104, which LOC is secured by collateral provided to LLC 108 pursuant to a Tri-Party Contract (C). The Lender/Intermediary contract (A) also provides for stock liquidation transactions of the collateral as required by the Tri-Party Contract (C).

In the present embodiment, Tri-Party Contract (C) supersedes the original financing contract (B) shown in FIG. 1A and provides for the following:

1. LLC 108 will be formed by the parties 102, 104, 106 for the purpose of certain operating functions;

2. Intermediary 104 will own an interest in the LLC 108 until (a) termination of the contract (C) or (b) the term of the contract (C) expires. At the end of the loan term, the client will secure 100% ownership of its own fully-funded finance company (i.e., LLC 108);

3. Client 106 will purchase a membership interest in the LLC 108 with its stock. In one embodiment, Client 106 purchases a majority interest in the LLC and the Intermediary 104 obtains a minority interest;

4. Intermediary 104 will provide the LOC to the LLC 108/Client 106 pursuant to certain credit provisions and subject to Intermediary credit policies, secured by the client's assets and the client's stock owned by LLC 108;

5. Intermediary 104 will provide to the LLC 108 certain asset (e.g., accounts receivable) servicing pursuant to the LLC Operating Agreement;

6. Intermediary 104 will provide to the LLC 108 certain Stock Monitoring services pursuant to the Operating Agreement;

7. Intermediary 104 will provide to the LLC 108 certain accounting, tax and legal services pursuant to the Operating Agreement.

Those skilled in the art will appreciate, based on the disclosure herein, that the legal structure of the present embodiment has the following additional benefits:

1. Marketing—enables the client to avoid the negative stigma of assigning the client's assets to an unknown finance company;

2. Image—enables the client to improve its image with its customers by having its own finance company (e.g., similar to the Ford Credit/Ford Motor Company relationship).

3. Ownership—enables the client, at the end of the loan term, to secure 100% ownership of its own finance company that is properly funded with the balance of the proceeds from the stock liquidations.

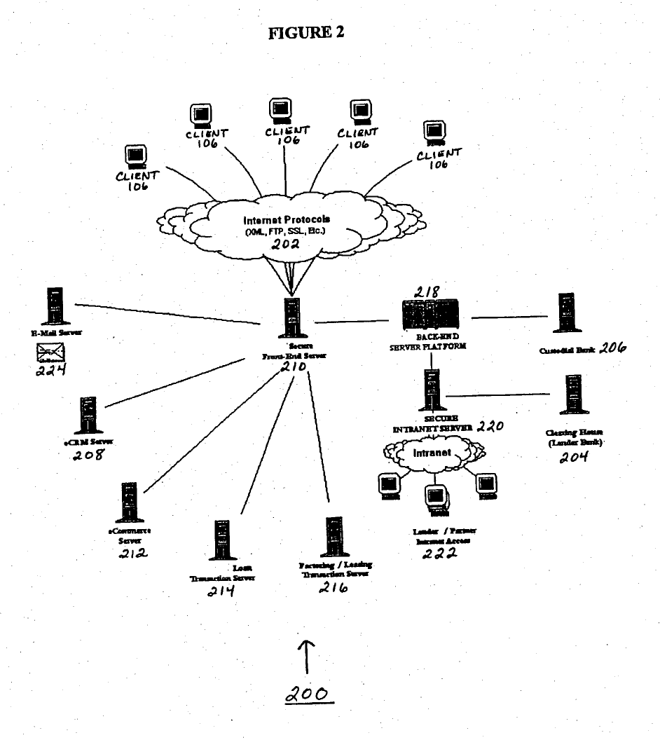

Having described methods of certain embodiments and the relationships among the entities involved therein, one exemplary system for implementing and supporting the method according to one embodiment will now be described with reference to FIG. 2 and continuing reference to FIGS. 1A and 1B. It should be understood that any number of different systems, computerized or otherwise, may be used to implement the foregoing methods; FIG. 2 shows the system architecture of one embodiment. This system 200 makes judicious use of technology and e-commerce that streamlines the operations of the system of the present embodiment and enhances client contact and convenience. A robust suite of Internet protocol (202) capabilities is designed to serve multiple groups, i.e., (a) clients and client's customers 106, (b) operational/credit/financial management of Intermediary's 104, (c) Intermediary bank 204, (d) Intermediary custodial bank 206, and (e) prospective clients and general Internet traffic. The Web-enabled system shown in FIG. 2 also gives clients 106 and vendors secured access to online, real-time information stored in a proprietary database, which saves both time and money. Computer access to live data by clients and vendors access eliminates phone calls and the need to fax and mail reports.

The system includes a computerized database system and an electronic customer relationship management (eCRM) server (208) to track and control sales calls and other customer contacts relevant to sales functions to retain and expand Intermediary client base. This element of the system permits individual salespeople and their supervisors to track every contact and analyze the effectiveness of the Intermediary's sales and marketing efforts.

The system is designed to run from any type of Web browser and presents the data to clients in a format that Internet users are accustomed to seeing. It was also designed to give clients and vendors extremely fast access to their information, regardless of their connection speed. As an example, when the fixed asset collateral is accounts receivable, they have the ability to view balances with available credit limit; invoices; compare invoices to payment information; enter invoices online into verify mode; payment history for each/all account debtors; run real-time reports including:

1. ACCOUNTS MASTER lists all Accounts for one or all Clients, together with Debtor, i.e., the obligor on the receivable names and locations, account balances, and amounts that are past due.

2. AGING TREND shows a summary aging spread from month to month, for an Account or Debtor. This report is used to detect developing problems and to check seasonal trends in the aging of receivables.

3. BROKERS' COMMISSIONS computes Brokers' commissions and prints a Broker statement each month. This report can be sent to Brokers or used for internal salespersons. (It is customary in the finance and banking industries to pay loan brokerage or referral fees, which are typically a percentage of collected origination fees).

4. BROKER MASTER LIST lists names and addresses of commissioned Brokers who find Clients for Intermediary 104.

5. CHECK PRINTING is used for printing checks for either Schedule Advances or Reserve Disbursements.

6. CLIENT LEDGER is a daily breakdown of all activity for each Client 106. This report is designed for sending to each Client 106 as a monthly activity statement and fee analysis report.

7. CLIENT SUMMARY for each Client 106, this report summarizes all activity for any time period—cash received, cash disbursed, fees earned, reserve disbursed, assignments/purchases, collections, advances, and net cash. This report shows collateral and loan balances, reserve account balance, unapplied cash, accrued fees, accrued reserve, and settlement amounts.

8. CLIENT TICKLERS lists events or activities that are approaching or have passed an expiration date or deadline, and which require some action on the part of Intermediary 104. The types of tickler dates and their frequency and tickler period are all user-defined.

9. COLLECTION lists collections from Debtors for any date range by Client 106. This report can be sent to the Client 106. Also used for end of the day balancing and as a bank deposit reconciliation report.

10. COLLECTION STATUS lists Invoices of a Client or Debtor that are past due by a specified number of days. This report is used by the collection department or as a basis for calling delinquent Debtors or as a management tool for previewing problem Clients. This report can also print invoices that have been skipped, Ticklers, Comments, and the like.

11. INVOICE AGING

12. PURCHASE AND ADVANCES REPORTS

13. RESERVE ACCOUNT REPORTS.

The entire system is security controlled, with only the options designated by Intermediary 104 available to each Client 106.

Clients 106 and prospective clients are able to submit loan applications, review the status of their applications, access product and pricing information, as well as manage their loan portfolios via the Internet protocols 202 to Intermediary's Secure Front-End Server 210.

Server 210 is the hub of the network and handles all the front-end Web pages utilizing HTML, JAVA scripting, and application server page (ASP) protocols. This server is the primary front-end Web server with robust features preferably capable of handling up to 10,000 simultaneous and unique sessions. Depending upon the end-user's purpose for accessing the intermediary's Web site, the server software can route the end-user to a variety of application/transaction server platforms as needed, e.g., eCommerce Server 212, Loan Transaction Server 214, and Factoring/Leasing Transaction Server 216. These varieties of application servers are Programmed to handle the transactions created by all of the lending activities of the system. For example, the factoring/leasing transactions will use its own server, Factoring/Leasing Transaction Server 216, while the accounts receivable financing transactions will use its own, Loan Transaction Server 216. However, each server will access Intermediary Secure Back-End Platform 218, which has load balancing and a hot spare backup to ensure maximum up time and includes a secure database. Database has nightly i weekly back-up routines pursuant to the Intermediary's policies and procedures.

Intermediary 104 uses the customer relationship management server platform, e.g., eCRM server 208, discussed above, to enhance client contact and convenience. Similar to the transaction servers discussed above, eCRM server 208 accesses Intermediary's Secure Back-End 218 while providing the client, as well as management, with real-time data and feedback.

Intermediary's Secure Intranet Server platform 220 is implemented for Intermediary's employees, branch offices and certain strategic partners, communicating through their respective servers and workstations, e.g., Lender/Partner Bank Servers 222, its Electronic Clearing House 204, and its Custodial Bank Server 206.

An E-mail Server 224 is provided as a separate server to handle Intermediary's internal and external email requirements, including back-up routines and security issues. The email Program will access Intermediary's Secure Back-End Database as part of its omnibus functions.

The following is a partial list of some of the software Programs and other features that are available in the present exemplary system:

1. Windows® Based system—designed from the ground up to be easy-to-use.

2. User-Defined Labels—Intermediary 104 can rename any field within the system for total flexibility, including multi-lingual labeling capabilities.

3. General Ledger Interface into the General Ledger Package Program used by the Intermediary 104.

4. Verification Processing via phone or verification letters.

5. Easy-To-Use Schedule Screen with Microsoft® ‘Add Wizard’ to make data entry very easy.

6. Payment Entry with searches by Client 106, Debtor, Invoice ID, P.O. Number and Amount. A check may be applied to any number of Invoices. Non-Factored amounts may be tied to specific invoices IDs.

7. Accruals of Income and Reserve Amounts are available at any time.

8. Extensive Fee Capability allowing Intermediary 104 to charge fees based on:

a. Incremental Rates based on unlimited buckets of time.

b. Daily Rates allows you to charge client fees based on a fixed rate or a prime. May be charged on the Invoice or Advanced amount, Full amount or Unpaid Balance, Compound Interest and varying Days in Year.

c. Fees on Net Funds Employed allows one to charge a fee based on Net Funds Employed in conjunction with an Incremental or Daily Rate.

d. Float Fees on Business or Calendar Days.

e. Fees tied to invoices allowing Intermediary 104 to use different rate tables for each Client's invoices.

f. Up front fees may be earned immediately or accrued until the Invoice is closed.

g. Reserves may be held until the Schedule is closed.

h. Fees charged on an invoice-by-invoice basis or when a threshold is reached.

h. Late or Finance fees may be charged to the account debtor.

i. Default charges, i.e., Wire, Expedite, will display at the time the schedule is entered. Amounts may be deducted for the Advance or Client's reserve.

9. Credit and Concentration Limits notify Intermediary when its is getting close to a Client, Debtor or Account's credit limits. Unique tracking feature monitors Debtor exposure across all Clients.

10. Unlimited User Defined Tickler system allowing Intermediary 104 to track any date sensitive items for Clients and Debtors—alerting the account manager of past events at logon time.

11. Special Reserve allows Intermediary 104 to hold a greater portion of its clients' cash reserve for contingencies.

12. Broker Commissions are calculated and reports are printed automatically.

13. Comprehensive Collection Module allows Intermediary 104 to help its Clients with their collections.

14. Unlimited Comments for any item in the system.

15. Check, Wire or DDA Printing for advance and cash reserve disbursements.

16. Full Security is available allowing users, clients and vendors to log directly into the online system, and view only the data that they have authority to view.

17. Comprehensive Help Features and excellent user manuals are also provided online.

18. State-of-the-Art Program design utilizing a Communications Server.

19. Open Database Connectivity. (ODBC) Compliant allowing Intermediary 104 to interface into any ODBC compliant Program.

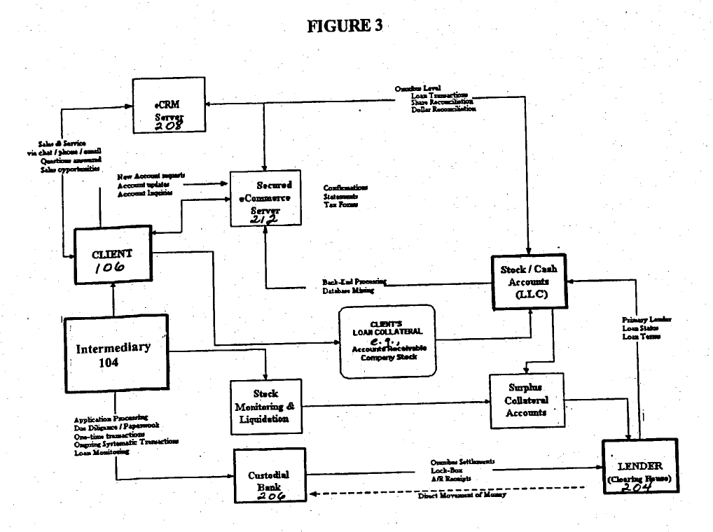

Once the legal structure and the credit policies and procedures are in place, an operational process, such as the exemplary process shown in FIG. 3, is used to address (a) transaction processing, (b) customer relationship management, (c) online updating and reporting functions and (d) credit and stock monitoring activities. These four distinct functions preferably are performed via an information technology platform, such as that of FIG. 2, that has the capability of automatically, and in real time, integrating the credit parameters with the stock monitoring and liquidation procedures.

As illustrated in FIG. 3, the Client 106 can perform various client account functions, including setting up new accounts, updating existing accounts, and submitting account inquiries, via the secure eCommerce server 212. In responding to such requests, the secure e Commerce server 212 accesses the back end of system 200, including the database, to retrieve the relevant information on the client's stock/cash account. The Client 106 may also initiate sales and service requests via the eCRM server 208, which also accesses information pertaining to the stock and cash accounts, including information on loan transactions, share reconciliation and dollar reconciliation. Also illustrated, is the provisioning by the Client 106 of loan collateral, which as noted above, includes pledged assets, such as accounts receivables, and company stock.

Intermediary 104 begins various operations as illustrated including stock monitoring and liquidation, the proceeds of which are supplied to the surplus collateral account for the respective Client 106. Additionally, Intermediary 104 interfaces with the Custodial Bank 206 in connection with application processing, due diligence, one time transactions such as account receivables, ongoing systematic transactions, loan monitoring and the like. As will be apparent to those skilled in the art, in performing the various functions, Intermediary 104 also interacts with Client 106.

Intermediary's Custodial Bank 206, in turn, handles the omnibus settlement with the Lender's Clearing House 204, which handles the status of all loans and their terms. Custodial Bank 206 also interacts with the Clearing House 204 in connection with lock-boxes and accounts receivable receipts.

The Lender Clearing House 204, in turn, supports the stock and cash accounts handled by LLC 108, including providing information regarding the Lender 102, loan status and loan term.

The stocks and cash accounts are handled by LLC 108, which performs the back-end processing and accepting of the loan collateral. LLC 108 is in communication with the secured eCommerce server 212 that receives all account requests, updates all accounts and handles all account inquiries from client 106. The server 212 houses the database Programs and handles all database mining of the database files of the back-end server platform 218. Furthermore, server 212 handles confirmation of the status of all loans to client 106, as well as providing periodic statements of the necessary tax form information to client's 106. At the omnibus level, the servers 208 and 212 share a loan transaction, stock reconciliations and reconciliations of the financial statements received from the LLC 108.

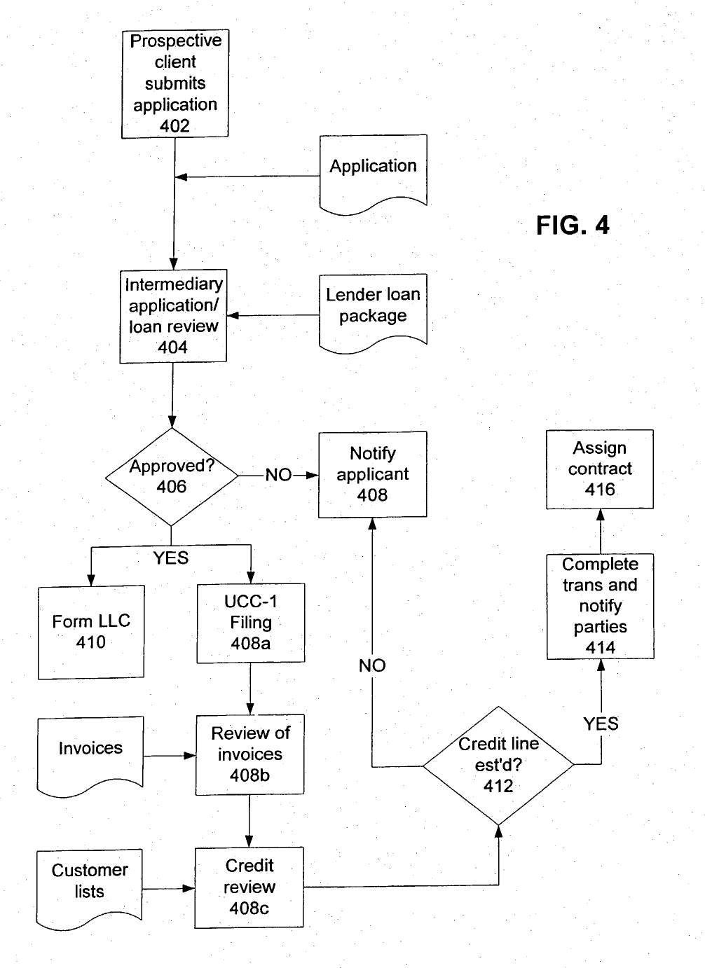

An exemplary overall loan processing flow will now be described with reference to FIG. 4 and continuing reference to FIG. 1B and 2. In general, the loan processing begins with a perspective client submitting a loan application to the Intermediary 104. Step 402. As described. above, because the client is pledging certain of its assets and company stock is collateral for a loan, the application includes information on such assets, as well as client specific information, including business and trade name, address, industry section, website, stock exchange on which the company is traded as well as the company symbol, company's transfer agent, state of incorporation, tax ID numbers, accounts receivable details and agent reports, A/P details and Aging Reports, Insurance Details, Bank Account Details, Legal Counsel, Accounting/Audit Firms Financial Statements and Recent SEC filings.

The Intermediary's loan review committee reviews the application for completeness and conducts due diligence on the viability of the transaction. Step 404. For example, the loan review committee performs a UCC-1 search, an analysis of the company's securities, a legal analysis, and lender analysis and an in-house credit review, all in connection with determining whether or not the prospective client is suitable for the Program. As part of the loan review committee's review of the application, the loan package is provided from Lender 102 to Intermediary. Subject to review by the committee and further credit review by the intermediary's credit committee, the application may be approved. Step 406.

If the application is approved, the process proceeds with a UCC-1 filing (Step 408a) and a detailed review of the assets being pledged. In the case of accounts receivable, such review entails examining actual invoices and the customer lists, all of which may be transferred electronically to the Intermediary's system. Steps 408band 408c.

Upon approval of the loan, the Limited Liability Company 108 is formed, the required registrations made in preparation for the company stock to be transferred to the LLC 108. Step 410. In connection with establishing the LLC 108, various legal and other formalities are tended to, including obtaining articles of organization, an operating agreement, a tax ID number and bank account. Additionally, a membership interest, capitalization/distribution, pledge of interests and authorization to liquidate stock are all established and obtained.

Subject to the foregoing review, including invoice verification and invoice matching pursuant to the intermediary's credit policies, the LOC may be established. Step 412. If so, the LLC transaction is completed by actually transferring the company stock, assigning the accounts receivable to intermediary 104, executing the various services agreements with Intermediary 104 authorizing stock liquidations, and the like. Furthermore, Intermediary 104 notifies the client's customers that payments on the accounts receivable should be directed to it. Additionally, Intermediary 104 notifies the Lender 102 and Client 106 of the final approval, and sends the relevant loan documentation to the Lender 102, requests the release of funds from the Lender 102, and, upon authorization, funds the client loan.

Once the line of credit contract is assigned to the Lender 102, the Lender 102 releases funds pursuant to the LOC.

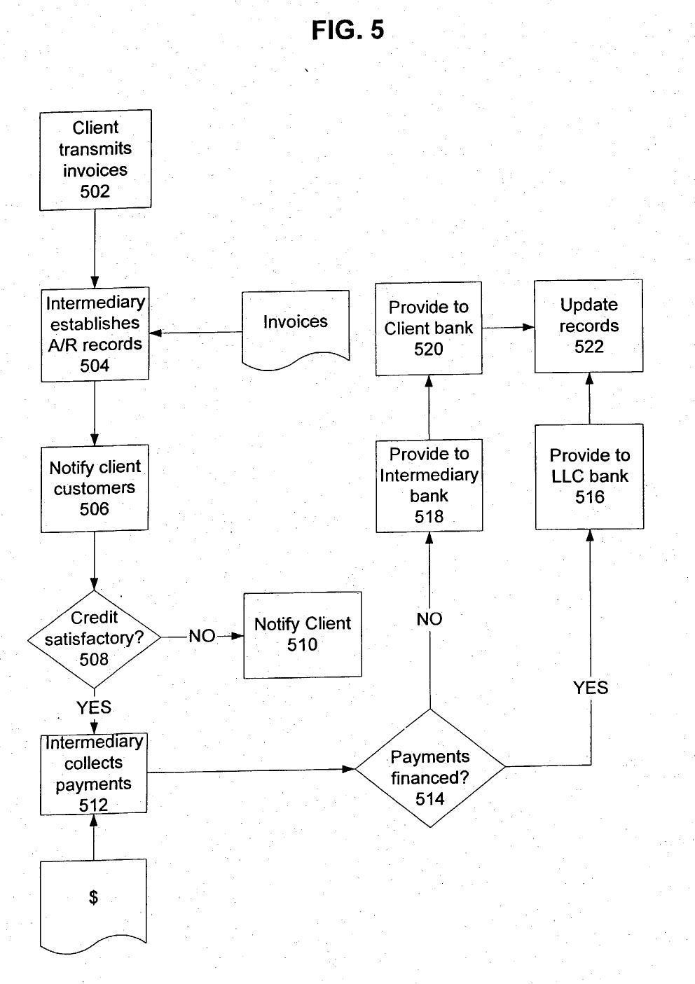

An exemplary overall process of processing accounts receivable will now be described in greater detail with reference to FIG. 5 and continuing reference to FIGS. 1B and 2. As an initial matter, files pertaining to the accounts receivable must be established. This entails receiving details on the accounts receivable from the Client 106, for example, via the loan application (Step 502) and creating database records for the Client 106 as well as the individual accounts receivable. Step 504. To this end, Client 106 preferably transmits all invoices electronically to Intermediary 104

Once the information is entered in the intermediary's database, Intermediary 104 proceeds to notify the client's customers that Intermediary 104 has taken over collecting the accounts receivable and that the client's customers should make payment to Intermediary 104. Additionally, Intermediary 104 verifies that the pledged accounts receivable satisfies its credit parameters. Step 508.

Once the accounts receivable files are established and review complete, Intermediary 104 can begin receiving and processing payments. Step 512. To this end, as payments come in, Intermediary 104 processes such payments, including entering the data into its system, matching invoices with particular LLCs 108, and separating financed versus non-financed payments. Step 514.

In the case of finance payments, such payments, less fees, are provided to the LLC bank accounts. Step 516. On the other hand, non-financed payments, less fees, are provided to intermediary's bank account. Step 518. These non-financed payments are then transferred from intermediary's bank account to the Client 106, less any fees. Step 520.

As the payments come in, Intermediary 104 updates the client files accordingly, including checking the LOC parameters for client and for client's customer minimums. Step 522. Intermediary 104 may also increase LOC funds available, less fees, to client 106. Intermediary 104 also pays down the LOC with the Lender 102 according to its terms, and intermediary 104 charges the relevant fees pursuant to any service contracts that it may have with the Lender 102 and/or LOC 108.

Having updated the records, Intermediary 104 may also chose to institute collection procedures for overdue invoices. Additionally, in the present embodiment, Intermediary loan is on a recourse to the extent the Client 106 must repurchase any accounts receivable that are overdue beyond a certain period, for example, ninety days. Thus, Intermediary 104 may also notify Client 106 of any such accounts.

With the intermediary's system and database updated with the received payment information, client's 106 can access the secure website and otherwise make inquiries as to the status of the accounts. Similarly, customized reports and notifications may be generated by Intermediary 104 for both internal and external purposes.

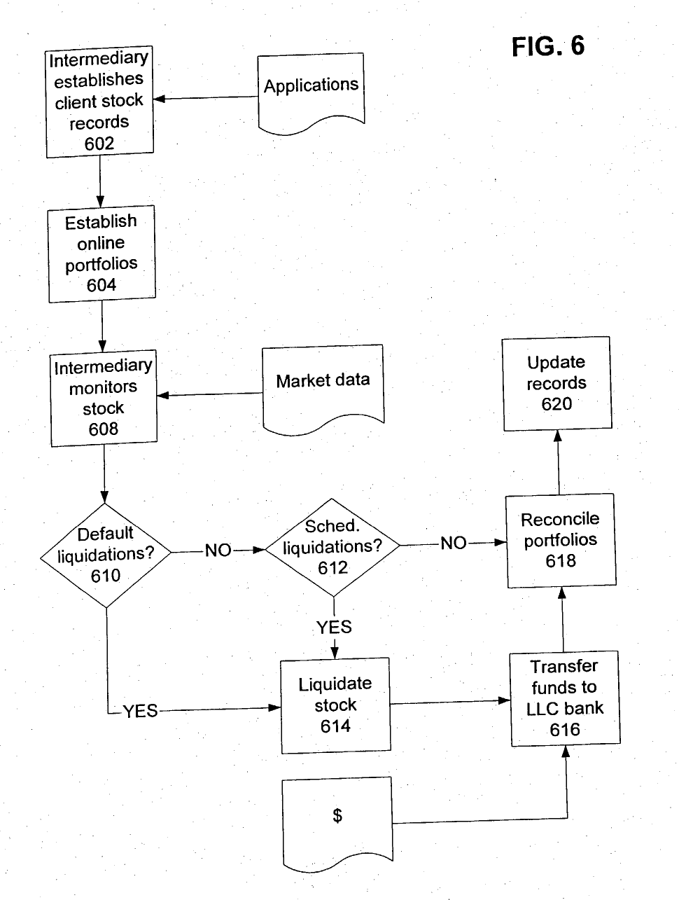

An exemplary stock portfolio management process will now be described in greater detail with reference to FIG. 6. In general, the process begins with Intermediary 104 establishing client stock records, Step 602. This entails identifying the client, setting up website access, assigning staff and verifying the transfer agent for the client. Furthermore, each record includes various client and stock identifying information, typically provided as part of the loan application. These files are used in establishing on-line portfolios for the intermediary's clients 106. Step 604. Establishing the on-line portfolios includes setting up the database records, obtaining transfer agent authorization and setting up automatic alarms, which indicate whether certain clients 106 and/or stock violate certain parameters. By way of example, alarms may be generated if stock prices fall below a certain amount, or a certain regulatory or other legal action is taken against a client 106.

Once the portfolios have been created, Intermediary 104 monitors the stock. In so doing, Intermediary 104 receives preferably real time data feeds of market information, including stock prices. The stock monitoring further includes monitoring stock price and variance, trading volume and variance, capitalization parameters, insider trading, stock trends (e.g. daily, weekly, monthly; moving averages, and the like), liquidations, press releases, economic and market factors, client 10K's and 10Q's, analyst reports, L.O.C. parameter and variance, the amount of cash in the surplus collateral account and the like. Such monitoring continues throughout the entire process. Once the portfolios have been created and are being monitored, Intermediary 104 proceeds to determine whether or not there are any liquidations to be affected. More specifically, intermediary routinely determines whether or not there are default liquidations (Step 610) or whether there are monthly or otherwise scheduled liquidations (Step 612). If either types of liquidation are required, Intermediary 104 causes the appropriate amount of stock to be liquidated. Step 614. The proceeds are then transferred to the LLC bank. Step 616.

Intermediary 104 routinely reconciles the stock portfolios. Step 618. In so doing, Intermediary 104 reconciles the LLC parameters and the value of the surplus collateral account, increasing the LLC funds available (less fees), when appropriate. In accordance with the intermediary's contracts, it also withdraws liquidation and other service fees from the prospective accounts.

After such reconciliation, the portfolio records are updated. Step 620. Having assured that the records are accurate, various reports may be generated for both internal and external use and such records may be made available, for example, via the secure website to clients 106 and the lender 102.

Factoring:

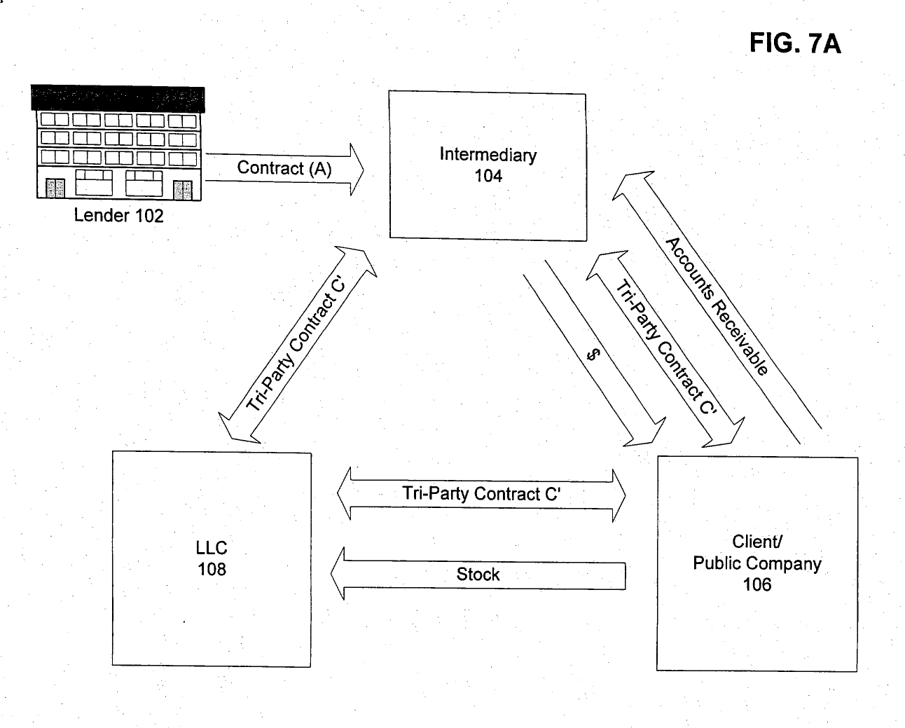

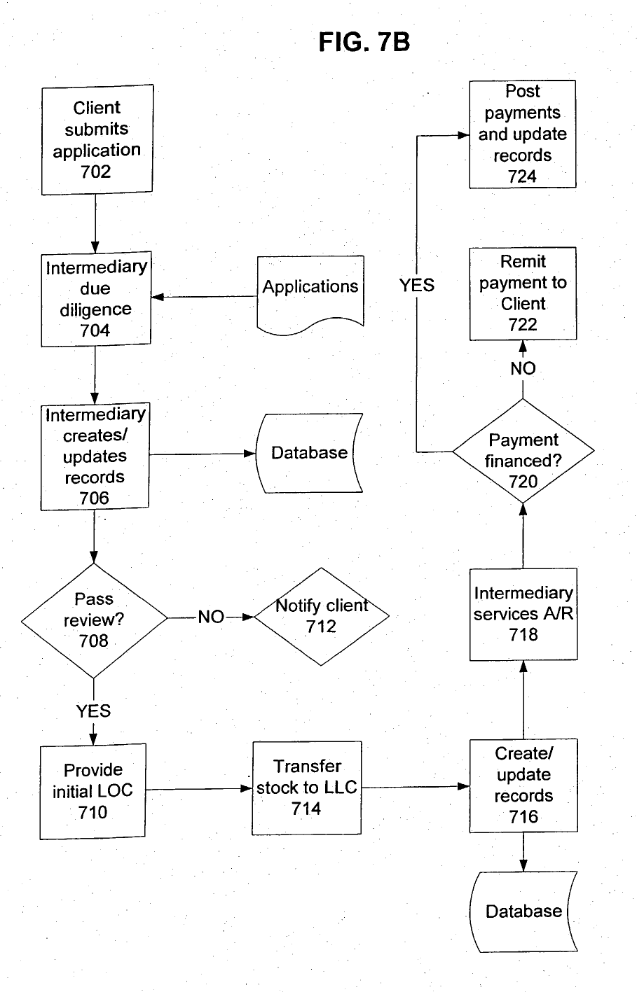

Although the foregoing embodiments have been described primarily in terms of providing a LOC to the client, it is within the scope of the present invention to provide other sources of financing and loans to clients utilizing the methods and systems disclosed herein. For example, in certain embodiments the general legal and business arrangements of FIG. 1B may be utilized by the intermediary when acting as a factor, purchasing accounts receivables from the client either directly or through the LLC. One exemplary arrangement where the intermediary acts the factor, purchasing the accounts receivable directly from the Client, is illustrated in FIG. 7A.

As illustrated therein, as with the prior embodiments, Intermediary 104 has a contractual arrangement (Contract (A)) with the Lender 102 whereby the Lender 102 provides a LOC to Intermediary 104 that is secured by any one or more pledged a tri-party contract (C′), which parallels the tri-party contract previously discussed. Also as with the prior embodiment, the Intermediary 104 enters a tri-party contract (C′) with the Client 106 and a financing company, such as a LLC 108.

Pursuant to the tri-party contract (C′) of the present embodiment, Intermediary 104 agrees to purchase accounts receivable from Client 106 at a discount rate on a recourse basis. In the present embodiment, such recourse is achieved by requiring 106 to transfer stock (either free-trading or affiliate, as previously discussed) into LLC 108. As with the prior embodiments, such stock may be liquidated during the term that the accounts receivable are outstanding or may be held by the LLC 108 to be liquidated in the event the accounts receivable (or any portion thereof) are not collected for a period of time (e.g., if a receivable is over ninety days past due). Notably, the protection afforded Intermediary 104 by virtue of the collateral stock protects Intermediary 104 against the risk of not collecting on the accounts receivable and consequently, allows Intermediary 104 to provide Clients 106 factoring at a higher discount rate that traditionally provided. Furthermore, while traditional factoring on a recourse basis would typically entail the factor (e.g., intermediary 104) agreeing to pay a portion of the fee up-front, with the remainder of the fee being paid when the purchased accounts receivable are collected, is not required (although possible). Instead, a greater amount of cash can be provided to Client 106 up-front, rather than withholding cash until collection. In short, the present embodiment allows Intermediary 104 to pay Client 106 an up-front payment at a relatively higher discount rate, without withholding any payment, because the stock collateral held by LLC 108 provides Intermediary 104 sufficient recourse.

As with the prior embodiments, the value of the stock collateral may vary depending upon the result of an analysis of various factors affecting the risk assumed by intermediary 104, as well as the shares outstanding, number of shares pledged as collateral, trading price, liquidity and other business and credit factors. In the present embodiment, the value of the stock collateral is determined based on the value of the purchased accounts receivable, the amount that the up-front payment exceeds that provided under traditional discount rates and methods, the amount remaining uncollected from the purchased accounts receivable at any given time, and the like. Indeed, with the method of the present embodiment, utilizing the same previously outlined formulas and variable criteria, Intermediary 104 may provide cash advances to Client 106 prior to collections up to 100% of the value of the accounts receivable.

As with the previously described embodiments, the shares pledged and held by LLC 108 may be liquidated over time, in accordance with a financing plan agreed to in the contract (C′), or held as collateral for the representations and warranties regarding the validity of the sold receivables, among other things, made by the client pursuant to the sale of the accounts. In the event of a breach of such representations and warranties , the surplus cash can be distributed to Intermediary 104, and/or the stock collateral can be liquidated, the proceeds of which are provided to Intermediary 104. Until breach, the proceeds from liquidations are held in a Surplus Collateral Account by LLC 108.

Furthermore, the contract (C′) provides for margin type requirements. More specifically, Client 106 is contractually obligated to maintain the value of the stock collateral above a stated minimum. Such minimum may be, for example, a multiple of the over-advance amount (i.e., the amount paid above that offered under conventional factoring discount rate), a multiple of the outstanding accounts receivable at any given time, or any other rational basis agreeable to the parties to the contract (C′).

Having described how Intermediary 104 may serve as a factor in the context of the present invention, an exemplary operational process of the Intermediary serving as a factor will now be described in greater detail with reference to FIG. 7B. The processing begins with a prospective client or client submitting an application, preferably via an online electronic submittal as with the prior embodiments. Step 702. Also as with the prior embodiments, the application preferably includes information identifying the (prospective) client, as well as financial information and particulars regarding the accounts receivable to be purchased. The application information is entered into intermediary's database.

As with the prior embodiments, the loan review committee of Intermediary 104 performs due diligence on the application, including an analysis of the applicant, the accounts receivable and the applicant's customers. Step 704. During the review process, the status of the application is updated and made available to the applicant via the website. Step 706.

If the applicant/client 106 passes review (Step 708), Intermediaiy 104 provides cash advances to the client 106 up to the value of the purchased accounts receivable. Step 710. If not approved, the prospective client is notified of such. Step. 712. It is to be understood that it is within the scope of the present invention for the intermediary to first establish a maximum amount of credit that it will provide to a particular client and to provide the client a series of one or more loans up to that amount. The approval of the cash advance and the amount thereof are noted in the client 106 record in the database.

Having provided the cash advance, Intermediary 104 further proceeds to establish customer records in its database, verifying the accounts receivable invoices and noting the details thereof, including due dates and balances. Step 716.

Intermediary 104 proceeds to service the accounts receivable, reconciling on the invoices and applying received payments to appropriate invoices. Step 718. Specifically, the matching between payments received and invoices is done electronically, updating the intermediary's database accordingly to allow for automatic tracking and review of accounts. As part of the process of collecting and posting receivables, Intermediary 104 further performs daily bank clearances, reconciles payments on open balances, identifies any customer objections and/or discrepancies on payments, adjusts balances accordingly, follows up on overdue receivables and reports previous advances as appropriate.

It should be noted that in certain embodiments, Intermediary 104 may service accounts receivables in addition to those that it has financed. In such cases, Intermediary 104 determines whether the received payment corresponds to a financed receivable (Step 720). If not, remits the non-financed payables received from customers to the Client 106 (less any fees). (Step 722); if so, Intermediary posts payments to appropriate accounts and updates its records. Step 724.

Then, during and after the collection and posting of receivables, Intermediary 104 utilizes its information technology infrastructure, updating the database and, accordingly, its website. Furthermore, Intermediary 104 has reporting capabilities, including providing individual and summary transaction information, compiling and forwarding dispute and deduction information to client 106, generating detailed monthly statements, as well as daily, monthly, quarterly and yearly reports for its own use. Such reports include, for example, reports providing amounts. past due, aging trend reports, client ledger/summary reports, client tickler reports, collection status reports, LOC parameter reports, for both clients 106 and their customers, penalty/default reports, receipts and income reports, end-of-month accounts receivable reports, for purposes of credit insurance, and the like.

It should be noted that throughout the period that a loan is outstanding and for which the receivables remain due, Intermediary 104 monitors the Client 106, its customers and the purchased accounts receivable. In the event of a default (for example, a client customer being a certain time and/or amount overdue or in arrears). Intermediary enforces the provision of the contract calling for liquidation of stock held by LLC, repurchase of accounts by Client 106, and/or any other action called for in the contract C. Without departing from the spirit and scope of this invention, one of ordinary skill in the art can make various changes and modifications to the invention to adapt it to various usages and conditions. For example, it is within the scope of the present invention to perform steps of the processes described herein in different orders, utilize different system architectures, hardware and software, modify time periods identified herein, and the like. Furthermore, certain embodiments do not require both intermediary and lender; a single entity may perform some or all of the functions. Moreover, the particular formulae used herein are exemplary, as the structure and methods disclosed herein are amenable to use with other formulae. As such, these changes, modifications and alternatives are properly, equitably, and intended to be, within the scope of the following claims.

What is claimed is:

1. A method of providing a publicly traded company funding in an amount, A, the method comprising:
identifying fixed assets of the company, the fixed assets having a value, V, to be pledged as collateral to secure funding,
identifying a number, N, of shares of listed stock having a price per share, P, to be pledged as additional collateral to secure the funding;
determining an advance rate percentage, R, of the pledged fixed assets;
determining a ratio, M, of total stock collateral value (N×P) to excess loan amount (A−(R×V)); and
approving the funding, A, where:
$$A = ( R \times V ) + \frac{( N \times P )}{M .}$$

2. The method of claim 1, wherein R is about 70 or greater.

3. The method of claim 1, wherein M is about 1 or greater.

4. The method of claim 1, wherein M is in the range of about 2 to about 20.

5. The method of claim 1, wherein A is about 110% or more of V.

6. The method of claim 1, wherein, prior to funding, the listed stock is owned by the publicly traded company desiring financing.

7. The method of claim 1, wherein, prior to funding, the listed stock is owned by an affiliate company of the publicly traded company desiring financing.

8. The method of claim 1, further comprising registering the shares of stock pledged as collateral by the company in the name of a newly formed entity.

9. The method of claim 1, wherein M is determined based on at least a risk analysis based in part upon the company, the pledged fixed assets, and stock.

10. The method of claim 1, wherein the fixed assets include one of the following types of assets: accounts receivable; equipment; inventory; and real estate.

11. A method of providing a publicly traded company funding in an amount, A, the method comprising:
receiving at least one application for a loan from the company, the application including information identifying at least (i) the name of the company, (ii) fixed assets of the company, the fixed assets having a value, V, to be pledged as collateral to secure funding, and (iii) a number, N, of shares of listed stock having a price per share, P, to be pledged as additional collateral to secure the funding;
determining the advance rate percentage, R, of the pledged accounts;
determining a ratio, M, of total stock collateral value (N×P) to excess loan amount (A−(R×V)); and
approving the funding, A, where:
$$A = ( R \times V ) + \frac{( N \times P )}{M}$$
establishing a separate entity, and
registering the shares of stock pledged by the company in the name of the separate entity.

12. The method of claim 11, wherein the separate entity is a limit liability company.

13. The method of claim 11, further comprising liquidating the shares of stock to generate cash.

14. The method of claim 13, wherein the shares are liquidated periodically according to a liquidation plan.

15. The method of claim 14, wherein the funding is for a term and the separate entity is partially owned by the company during the term, the method further comprising providing full ownership of the separate entity to the company upon satisfaction of funding obligations, thereby providing the company with a funded financing company.

16. The method of claim 11, wherein the funding is for a term and the separate entity is partially owned by the company during the term, the method further comprising providing full ownership of the separate entity to the company upon satisfaction of funding obligations.

17. The method of claim 11, wherein the company receives the funding pursuant to an agreement the method further comprising liquidating the shares of stock upon breach of the agreement.

18. A method of a first party funding a second party, the second party being a publicly traded company, the method comprising:
purchasing accounts receivable of the company at a discount rate;
establishing an entity legally distinct from the company and the first party;
transferring shares of a publicly traded security into the separate entity, the shares being collateral for purchasing the accounts receivable such that the discount rate is greater than an industry comparable discount rate for purchasing the accounts receivable without the shares as collateral.

19. The method of claim 18, wherein the first party is an intermediary.

20. The method of claim 18, wherein the first party is a lender.

21. The method of claim 18, further comprising entering into a tri-lateral contract among the company, the separate entity and the lender governing liquidation of the shares.

22. The method of claim 21, wherein the lender is an intermediary.

23. The method of claim 21, further comprising:
the company breaching the contract;
liquidating the shares in response to the company breaching the contract; and
the first party receiving at least a portion of proceeds from the liquidation of shares.

24. The method of claim 18, wherein funding is provided for a term, the method further comprising:
causing the shares to be liquidated during the term, thereby creating a surplus cash account associated with the separate entity;
collecting on the accounts receivable; and
causing the company to acquire ownership of the separate entity based on lender collecting on the accounts receivable.

25. The method of claim 18, wherein funding is provided for a term the method further comprising:
causing the shares to be liquated during' the term, thereby crating a surplus cash account associated with the separate entity;
failing to collect on at least a portion of the accounts receivable; and
receiving at least a portion of the surplus cash account based on uncollected accounts receivable.

26. A system for providing funding in an amount, A, to a publicly traded company based on fixed assets and shares of a listed stock via a communications network connecting a lender and a plurality of publicly owned companies seeking to secure financing, the system comprising:
means for receiving an indication of company fixed assets having a value, V, to be pledged as collateral to secure funding and a number, N, of the shares of the listed stock having a price per share, P, to be pledged as additional collateral to secure the funding;
means for determining on advance rate percentage, R, of the pledged fixed assets;
means for determining a ratio, M, of total stock collateral value (N×P) to excess loan amount (A−(R×V)); and
means for transmitting to the company an approval of the funding, where:
$$A = ( R \times V ) + \frac{( N \times P )}{M .}$$

27. A method for a company to receive funding, the method comprising:
pledging fixed assets as collateral for the funding, the pledged fixed assets having a standard advance rate associated therewith;
transferring publicly traded stock into a separate entity, the stock separate from the fixed assets; and
receiving funding at an effective advance rate greater than the standard advance rate.

28. The method of claim 27, wherein the effective advance rate is up to about 30% greater than the standard advance rate.

29. The method of claim 27, wherein the stock is liquidated according to a financing plan, the method further comprising:
satisfying finding obligations; and
receiving ownership of the separate entity, the separate entity suitable for use as a financing company.

30. The method of claim 29, further comprising using the separate entity as a funded financing company.

31. A method of receiving funding the method comprising:
selling accounts receivable, the accounts receivable having a standard discount rate associated therewith;
transferring publicly traded stock into a separate entity for liquidation;
receiving funding at an effective discount rate greater than the standard discount rate.

32. The method of claim 31, further comprising agreeing to liquidation of the stock during a period the accounts receivables are not overdue, proceeds from the liquidation to be placed in a surplus cash account.

33. The method of claim 32, wherein a first party provides the funding and further comprising agreeing to provide the first party proceeds of the liquidation in the event at least a portion of the accounts receivable are overdue.

34. The method of claim 32, further comprising receiving proceeds of the liquidation based on collection of the accounts receivables.

35. The method of claim 32, further comprising receiving ownership of the separate entity based on collection of the accounts receivable.
